(19) United States
(12) Patent Application Publication
(10) Pub. No.: US 2009/0173925 A1
(43) Pub. Date: Jul. 9, 2009

(54) Hydraulic bottle jack with a control valve having a control knob and an automatic return

(76) Inventor: Roger C. Turner, Newport Beach, CA (US)

Correspondence Address: Roger C. Turner, Suite 306, 280 Cagney Ln., Newport Beach, CA, 92663, US

(21) Appl. No.: 12/006,525

(22) Filed: Jan. 3, 2008

(51) Int. Cl. B66F 3/24

(52) U.S. Cl. 254/93 H

(57) ABSTRACT

A hydraulic bottle jack has a housing with an internal control valve having an external shaft that is rotatable in the counter-clockwise direction to open the valve for lowering the jack, and rotatable in the clockwise direction to close the valve for raising the jack. A control knob is mounted on the rotatable shaft for manually rotating the valve. A biasing means in the form of a torsion spring has one end fixed to the housing and the other end fixed to the rotatable shaft for automatically urging the shaft into the clockwise direction for closing the valve. The knob and the torsion spring can be used separately or combined. A kit includes a control knob and torsion spring and uses a method for retrofitting a standard jack to a jack having a control knob with automatic return. A control knob type wrench has an inner side that is engageable with a standard double-key head of the control valve for operating the valve. A tubular handle wrench has a control knob on the proximal end thereof for operating a standard double-key head of the valve.

### BACKGROUND OF THE INVENTION

The invention relates to a hydraulic bottle jack; particularly to a control valve of the hydraulic bottle jack having a hand operable knob, and an automatic return to close the valve.

Hydraulic bottle jacks are well known, and function in accordance with Pascal's principle wherein an incompressible fluid exerts equal pressure within a closed container; and in this case, the closed container includes a small cylinder (plunger chamber) interconnected to a large cylinder (piston lift chamber). The jack utilizes a small area pump plunger under a force to exert a high pressure on fluid within the plunger chamber and equally into a lift chamber and against the inner end of a large area piston. A one-way valve between the chambers enables the piston to be progressively raised. The differential in the area of the plunger and the area of piston, along with the leverage of a long pivotal handle, result in the hydraulic jack having tons of lifting capability, by only a few pounds of downward force on the end of the handle.

Referring to FIG. 1 (PRIOR ART), a typical hydraulic bottle jack 10 is shown having an internal hydraulic fluid control valve with an external rotatable shaft 12 of the prior art. The proximal end of the rotatable shaft has a diameter of about 38 inch and has a pair of opposed lateral pins 14 having a diameter of about 0.12 inch and a combined width of about 0.88 inch forming a “double-key head” 16.

The double-key head is engagable by a tubular handle 18 having a “slotted tubular wrench” 20 located in one end of the handle. A typical slotted wrench has an internal diameter of about 0.62 inch, an external diameter of about 0.88 inch, and opposed slotted openings about 0.20 inch wide and about 0.20 inch deep. The handle is also utilized in an actuator 22 having a tubular opening 24 therein to pump the jack. The rotatable shaft 12 is typically rotated in a clockwise direction to close the control valve for raising the jack, and rotated in a counter-clockwise direction to open the control valve for lowering the jack.

In operating the jack, the slotted tubular wrench 20 of the pump handle 18 is first fitted over the end of the rotatable shaft 12 and is rotated until the slotted openings of the wrench mate with and over the pins 14 of the double-key head 16 to engage the rotatable shaft. The handle is then rotated clockwise to close the control valve. The handle is then withdrawn from the rotatable shaft, and is inserted into the actuator opening 24, and is pumped up and down to raise the jack. To lower the elevation of the jack, the handle is withdrawn from the actuator opening, and is again fitted onto the end of the rotatable shaft, and is rotated counter-clockwise to release the control valve. The fluid flows from the lift chamber back into the reservoir, and the piston drops back within the housing of the jack.

The double-key head of the rotatable shaft and the slotted tubular wrench of the pump handle have been utilized for many decades to operate a hydraulic bottle jack. However, as described above, the operation of the jack involves multiple transfers of the tubular handle from the rotatable shaft to the actuator opening and back; and the control valve can not be rotated while simultaneously pumping the actuator, if needed, for seeking a precise elevation of the jack.

The limitation of the single handle to either maneuver the control valve for raising or lowering the jack, or to maneuver the actuator to raise the jack, can also present a safety issue. If the control valve is needed to be immediately closed or opened in an emergency situation, the wrench handle may not be immediately available or not quickly utilized to perform this task. It is very desirable to be able to maneuver the control valve immediately, independently and simultaneously with pumping the actuator, without the need of the tubular handle.

In the operation and function of a hydraulic bottle jack, the jack is predominately used with the control valve in the closed position. Once the control valve is closed, the tubular handle can be readily used in the actuator opening 24 to raise the jack. It is desirable to have the jack with a control valve having an automatic return that is always biased into the closed position. The jack is always ready to be raised, and if the control value were to be accidentally hit and rotated open, it would immediately self correct, and not fall completely down.

The above features are desirable in a new hydraulic bottle jack, and it would also be desirable if the millions of existing prior art jacks could be readily retrofit and converted to include these features.

In view of the foregoing, it is an object of the present invention to provide a hydraulic bottle jack with a control valve having a hand operable knob and does not require the use of a tubular handle.

It is another object to provide a hydraulic bottle jack with a control valve having an automatic return to the closed position.

It is another object to provide a kit of components for adapting the valve of a conventional hydraulic bottle jack to one having a control knob, and a control knob having an automatic return.

### SUMMARY OF THE INVENTION

The foregoing objects are accomplished with a hydraulic bottle jack having a housing with an internal control valve having an external shaft that is rotatable in the counter-clockwise direction to open the valve for lowering the jack, and rotatable in the clockwise direction to close the valve for raising the jack. An improvement includes a control knob mounted on the rotatable shaft for manually rotating the valve. Another improvement includes a means for biasing the control valve into the closed position. These improvements can be incorporated separately or combined.

Another improvement is to provide a control knob type wrench for operating the valve. Another improvement is to provide a tubular handle with a control knob on the proximal end thereof for operating the valve. Another improvement is to provide a kit of components and method for retrofitting a standard jack to a jack having one or more of the various improved features.

An example of the improvements includes the hydraulic bottle jack having a control knob on the rotatable shaft, and further having a biasing means in the form of a torsion spring having one end fixed to the housing and the other end fixed to the rotatable shaft. The knob can be rotated in the counter-clockwise direction for opening the control valve; and when the knob is released, the torsion spring automatically forces the shaft to rotate back in the clockwise direction for closing the valve.

The control knob can be suitable provided by a generally circular disc having an outer front face with an extended double-key head thereon for engagement by a slotted wrench of a tubular handle, and having an inner central hub for attaching the knob to the rotatable shaft.

The torsion spring is suitably provided by a cylindrical wire torsion spring having an inner coil with the end thereof fixed to the housing; and having an outer coil with the end thereof fixed to the control knob. The torsion spring can also be provided by a spiral-clock type torsion spring having an inner end fixed to the housing and an outer end fixed to the control knob. The basing means can alternatively be provided by an elastomeric compound attached to the respective components.

The standard hydraulic bottle jack has the internal control valve with an external rotatable shaft having a standard double-key head thereon. The jack can also be improved by a means for biasing the rotatable shaft into the closed position. In this example, the valve is opened with the conventional slotted wrench tubular handle, and the jack does not utilize the aforementioned control knob.

The biasing means can suitably be provided in the form of a torsion spring having one end fixed to the housing and the other end fixed to the rotatable shaft. Examples of suitable torsion springs include a cylindrical wire torsion spring and a spiral-clock type spring. The biasing means can alternatively be provided by an elastomeric compound attached to the respective components.

A kit of one or more components including a control knob can be provided for use with a hydraulic bottle jack having a housing with an internal control valve having an external shaft with a double-key head thereon for engagement by a slotted wrench tubular handle. The shaft is rotatable in the counter-clockwise direction to open the valve for lowering the jack, and is rotatable in the clockwise direction to close the valve for raising the jack. The control knob is a generally circular disc having an outer front face with an extended double-key head thereon for engagement by a slotted wrench tubular handle. The control knob has an inner central hub with a recessed cavity including a central cylindrical opening with a first pair of slotted openings therein for manually rotating the valve. The control knob is attachable to the rotatable shaft.

The kit further includes a torsion spring having one end attachable to the housing and having the other end attachable to the rotatable shaft for biasing the valve in the closed position. The recessed cavity in the inner central hub of the control knob preferably further includes a second pair of slotted openings therein arranged perpendicularly to the first pair of slotted openings.

A method of installing the kit on a stand hydraulic bottle jack comprises the following steps: preparing the housing to receive a fastener for securing one end of the torsion spring to the housing; securing one end of the torsion spring to the housing; securing the other end of the torsion spring to the control knob; pulling the control knob outward so that the recessed cavity of the inner hub is free of engagement with the double-key head of the rotatable shaft; rotating the control knob counter-clockwise at least 90°, and further until the next pair of slotted openings are aligned with the double-key head, for pre-loading and sufficiently biasing the control knob into the closed position; pressing the control knob inward with the recessed cavity of the inner hub engaged with the double-key head on the rotatable shaft; and securing the control knob to the rotatable shaft.

An improved handle is provided for an otherwise standard hydraulic bottle jack. The jack has a housing with an internal control valve having an external shaft with a-double-key head thereon that is rotatable in the counter-clockwise direction to open the valve for lowering the jack, and rotatable in the clockwise direction for closing the valve for raising the jack. The handle includes a tubular shaft having a slotted tubular wrench at the distal end thereof for engaging the double-key head of the jack, and has a proximal end with a control knob having a diameter of about twice the diameter of the tubular shaft for facilitating control of the valve.

### BRIEF DESCRIPTION OF THE DRAWINGS

While the novel features of the invention are set forth in the appended claims, the invention will be better understood along with other features thereof from the following detailed description taken in conjunction with the drawings, in which:

FIG. 1 (PRIOR ART) is a left front perspective view of a conventional hydraulic bottle jack;

FIG. 2 is a left front perspective view of a hydraulic bottle jack, with a control valve having a control knob of the present invention;

FIG. 3 is left side elevational sectional view of a jack with a control shaft having an automatic return, of the present invention;

FIG. 4 is left side elevational sectional view of another embodiment of a jack with a control shaft having an automatic return, of the present invention;

FIG. 5 is a sectional view taken along 5-5 of FIG. 4;

FIG. 6 is left side elevational sectional view of a jack with a control knob and having an automatic return of the present invention;

FIG. 7 is left side elevational sectional view of another embodiment of a jack with a control knob and having an automatic return of the present invention;

FIG. 8 is sectional view taken along 8-8 of FIG. 7;

FIG. 9 is an left front perspective view of the control knob (and wrench) of the present invention;

FIG. 10 is an left rear perspective view of the control knob (and wrench) of the present invention;

FIG. 11 is left side elevational sectional view of another embodiment for adapting a conventional jack with the control knob and automatic return features of the present invention;

FIG. 12 is a sectional view taken along 12-12 of FIG. 11;

FIG. 13 is an exploded left front perspective view of the invention shown in FIG. 11;

FIG. 14 is a left front prospective view of a conventional two-piece jack handle including the control knob of the present invention. and

FIG. 15 is a left front prospective view of an improved jack handle of the present invention.

### DETAILED DESCRIPTION OF THE INVENTION

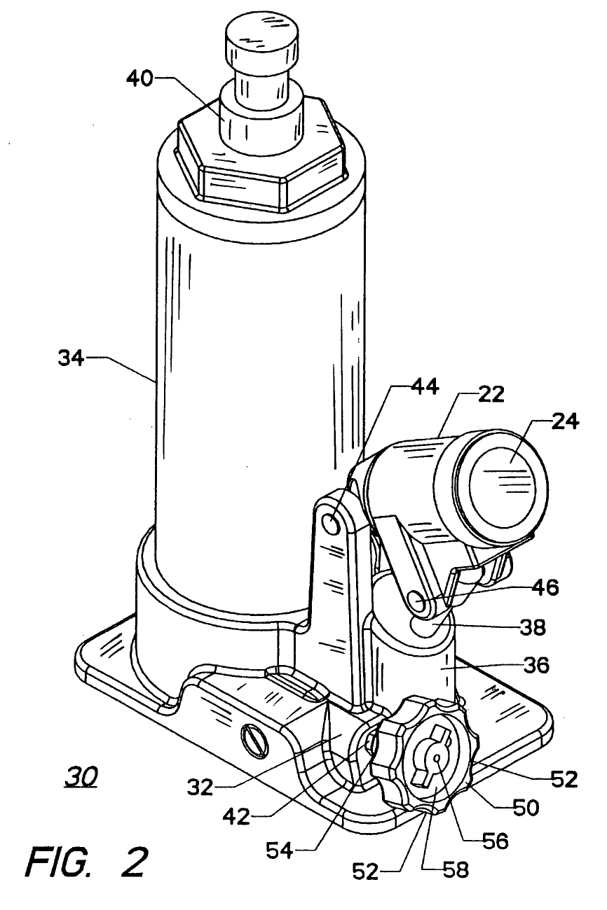

Referring now to FIG. 2, a first embodiment is illustrated for an improved hydraulic bottle jack 30 with a fluid control valve having a control knob of the present invention. The present invention relates only to external features and structure of the jack and the internal features are therefore not illustrated, but the internal features and functions are reviewed below in terms of the external structure.

The jack 30 includes a housing base 32 with a housing vertical portion 34 extending therefrom, with the vertical portion enclosing a hydraulic fluid reservoir and a lift chamber. The housing base includes a pump chamber (within housing vertical portion 36, and adjacent to housing vertical portion 34) with a pump plunger therein having an upper end 38 extending from the pump chamber. The lift chamber has a hydraulic piston therein having an upper end 40 extendable from the housing. An internal fluid passage interconnects the reservoir and the pump chamber and through a one-way valve to the lift chamber; and further includes a fluid passage interconnecting the lift chamber through a fluid control valve, back to the fluid reservoir. The control valve has an external rotatable shaft 42. The jack has the actuator 22 that is pivotally mounted (at 44) to the housing base and is further pivotally connecter (at 46) to the upper end of the plunger for sliding the plunger up and down, and pumping the fluid from the reservoir to the lift chamber.

The control valve has the rotatable shaft 42 extending from the housing base and is rotatable in the clockwise direction to close the valve for pumping the cylinder, and is rotatable in the counter-clockwise direction to open the valve to lower the cylinder. The rotatable shaft further includes a control knob 50 mounted on the proximal end thereof for manually rotating the control valve. The housing can further be designed to provide suitable recesses or peripheral flanges for protecting the control knob from unwanted lateral contact.

The control knob 50 (and its derivatives) is one of the basic components of the present invention. The knob is preferably in the form of a circular disc having a series of indentions 52 (or alternatively serrations or knurls) that can be readily gripped and controlled manually by one hand of an operator. A variety of ovals or polygons can be utilized as the shape of the knob. The knob is preferably cast in a suitable industrial metal material (steel, aluminum, etc.), or molded from a suitable industrial plastic material (Nylon, Delran, ABS, etc.).

The knob has a suitable mounting hub 54 with suitable fasteners (i.e. splines, keyway, set screw, etc.) for securely attaching the knob to the rotatable shaft. The diameter of the knob should not interfere with the housing base or the supporting surface and is typically about twice the diameter of the double-key head or otherwise about 1.50-2.00 inches in diameter.

A typical control value requires only about one-quarter revolution (about 90°) from fully closed to fully open position, and the critical transition occurs within a few degrees of rotation. The large 2.00 inch diameter of the knob (relative to the 0.88 inch diameter of the tubular handle) allows the operator to provide a larger but more gradual, precise torsional force on the rotatable shaft to finely control the valve, the rate of decent of the piston, and the elevation of the piston. This is particularly useful when trying to align and match the elevation of adjacent components, for leveling adjacent surfaces, or for aligning apertures for inserting an interconnecting fastener into adjacent components, etc.

The outer front surface of the control knob 50 preferably includes an outward extended double-key head 56 (similar to conventional head 16) for engagement in the conventional manner by the slotted wrench 20 of the tubular handle 18. This double-key head is preferably recessed within a cylindrical opening 58 for receiving the tubular handle. In certain situations, i.e. when the jack may be positioned far into the interior of a lifting project, the control knob may be more accessible with the tubular handle than by the hand of the operator. In such situations, the jack and control knob can function like the double-key head of a conventional jack and the tubular handle.

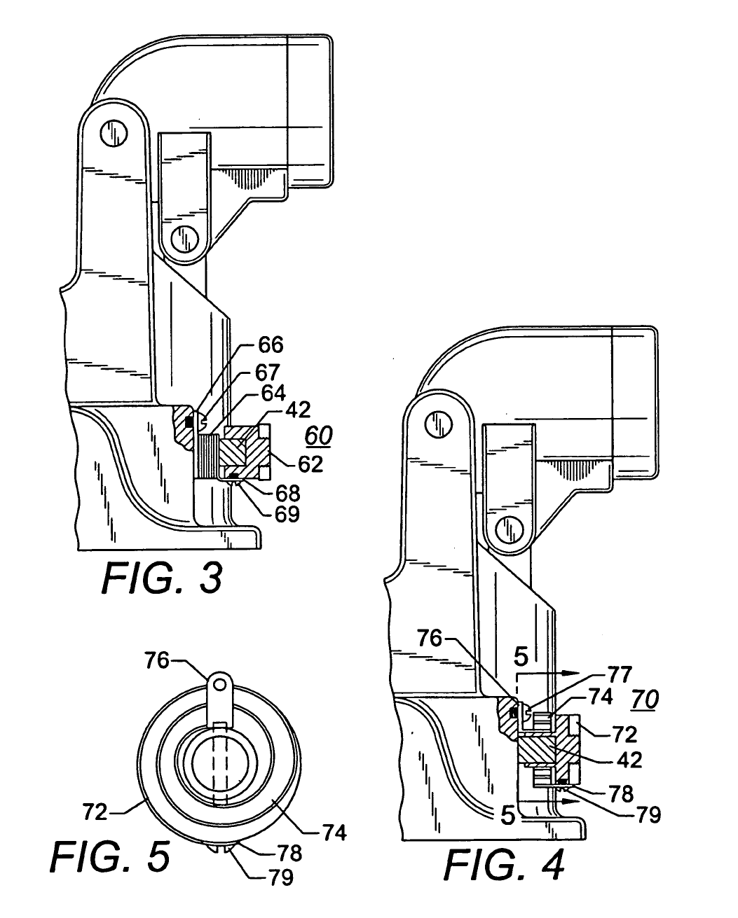

Referring now to FIG. 3, another significant improvement to a hydraulic bottle jack 60 is shown with the control valve having an automatic return to the closed position. The basic concept is to provide an otherwise conventional control valve with a biasing means (typically a torsion spring) to automatically and continuously urge the rotatable shaft into the closed position. The rotatable shaft can be rotated in the conventional manner with the tubular handle 18 in the counter-clockwise direction to open the valve to lower the jack. When the handle is removed, the torsion spring automatically forces the rotatable shaft to rotate back to the original position to close the control valve.

The biasing means can also be provided by an elastomeric compound having an inner portion secured to the rotatable shaft, and having an outer portion secured to the housing (or vice-versa). The elastomeric compound (suitably rubber) is generally in the form of a circular disc that is pre-molded and attached between the two components. Raw elastomeric material can alternatively be injected around the rotatable shaft and around recessed or extended members on the housing, and then cured to provide the biasing means. (The elastomeric disc has the same general function as a torsion spring.)

The rotatable shaft 42 includes the double-key head (similar to the conventional head 16) and is used in conjunction with the slotted wrench 20 of the jack handle 18 to open the control valve. In this example of a first embodiment, the double-key head is provided in the form of a cylindrical cap 62; and the biasing means is provided in the form of a cylindrical wire torsion spring 64. The wire torsion spring is positioned longitudinally around the rotatable shaft and the cylindrical cap is attached to the proximal end of the rotatable shaft. The wire torsion spring has an inward coil with the end 66 attached to the housing with a suitable fastener 67; and has an outward coil with the end 68 attached to the rotatable shaft, as shown, by attachment to the cap 62 with a suitable fastener 69.

The inward end and the outward end of the cylindrical torsion spring 64 are designed and fastened so that the cylindrical cap 62 is pre-loaded with sufficient torsional force to ensure that the control valve is normally securely biased into the closed position.

The example, as shown in FIG. 3, is rather simple with the components spaced to more clearly illustrate the invention. In a production design, the components are preferably more compactly designed to nest within the housing, and the cap is preferably integrally formed onto the rotatable shaft for surrounding and protecting the torsion spring.

Referring now to FIG. 4 and 5, an example of another embodiment of an improved hydraulic bottle jack 70 is shown with the control valve having an automatic return to the closed position. In this example, the double-key head is provided in the form of a cylindrical cap 72; and the biasing means is provided by a spiral-clock torsion spring 74. The spiral-clock torsion spring is positioned laterally around the rotatable shaft 42, and the cylindrical cap 72 is attached to the rotatable shaft. The spiral-clock torsion spring has an inner portion with an end 76 attached to the housing with a suitable fastener 77; and has an outer portion with an end 78 attached to the rotatable shaft, as shown, by attachment to the cap 72 with a suitable fastener 79.

This spiral torsion spring of FIGS. 4 and 5 functions similarly as discussed in reference to the cylindrical wire torsion spring of FIG. 3; and has the advantages of a compact shape, relatively strong torsional force, and flexibility. This example is also shown with the components positioned to more clearly illustrate the invention. In a production design, the spiral torsion spring is preferably recessed or nested within the housing and the cylindrical cap 72 is integrated with the rotatable shaft 42 for a more compact enclosed design.

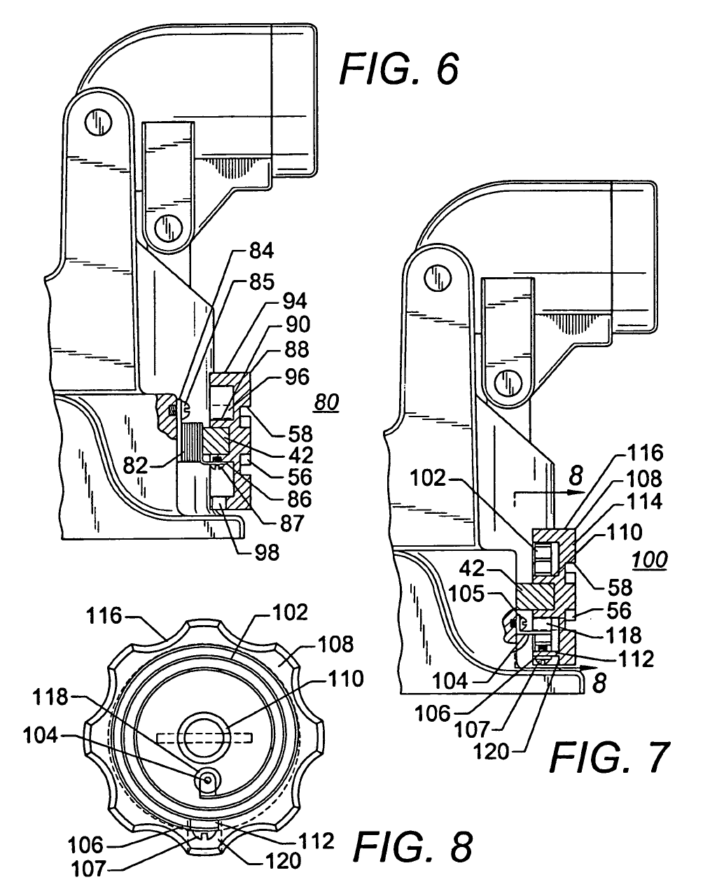

Referring now to FIG. 6, an example of a preferred embodiment of an improved hydraulic bottle jack 80 is shown featuring the control valve having a control knob combined with an automatic return to the closed position. The jack 80 has the rotatable shaft 42 extending from the housing as previously discussed. In this example, the automatic return is provided by a cylindrical wire torsion spring 82 positioned longitudinally around the rotatable shaft. The torsion spring 82 has an inward coil with an end 84 secured to the housing with a suitable fastener 85, and has an outward coil with an end 86 secured to the rotatable shaft by a suitable fastener 87.

A control knob 88 (having generally the same structure and features as previously discussed in reference to control knob 50 as shown in FIG. 2) has a central inner hub 90 attached to the rotatable shaft 42, and is further utilized to secure the outward end 86 of the torsion spring 82 to the rotatable shaft. The control knob 88 has the shape of a circular disc having an outer front face 92 with the extended double-key head 56 within the recessed cylindrical opening 58 that is engagable by the slotted tubular wrench 20 of the tubular handle 18. The recessed opening provides some protection for the double-key head during use and facilitates engagement of the double key head by the slotted wrench of the tubular handle.

The control knob 88 preferably includes a peripheral shirt 94 for enclosing the torsion spring and providing a protective, clean appearance. In the present example, the control knob further includes a suitable longitudinal access aperture 96 through the front face for installing and servicing the fastener 85, and a suitable lateral access aperture 98 through the shirt for installing and servicing the fastener 87.

The jack 80 is always ready to be deployed by positioning the jack and then pumping to the desired elevation. When the lifting project is completed, or the height of the piston needs an adjustment, the operator grasps the control knob and rotates it counter-clockwise as precisely as needed to gradually lower the jack. The jack handle can remain within the actuator opening in the event that pumping is needed. When completed and fully lowered, the control knob is released and it automatically rotates clockwise to close the valve, and is always ready for the next lifting project.

Referring now to FIGS. 7 and 8, an example of another embodiment of an improved hydraulic bottle jack 100 is shown featuring the control valve having a control knob combined with an automatic return to the closed position. The jack 100 has the rotatable shaft 42 extending from the housing as previously discussed. In this example, the automatic return is provided by a spiral-clock torsion spring 102 positioned laterally around the rotatable shaft. The torsion spring 102 has an inner portion with an end 104 secured to the housing with a suitable fastener 105, and has an outer portion with an end 106 secured to the rotatable shaft by a suitable fastener 107. (As a matter of design choice, the inner portion may alternatively be designed to be secured to the rotatable shaft, and the outer portion secured to the housing.)

A control knob 108 (having generally the same structure and features as previously discussed in reference to control knob 88 shown in FIG. 6, with the following additional features) has a central inner hub 110 attached to the rotatable shaft 42, and has an extended flange 112 for securing the outer portion end 106 of the torsion spring 102 to the knob (and thus to the rotatable shaft). The control knob 108 has the shape of a circular disc having an outer front face 114 with the extended double-key head 56 formed within the recessed cylindrical opening 58 and is engagable by the slotted tubular wrench 20 of the tubular handle 18.

The control knob 108 preferably includes a peripheral shirt 116 for enclosing the torsion spring and providing a protective, clean appearance for the jack. In the present example, the knob further includes a suitable longitudinal access aperture 118 through the front face for installing and servicing the fastener 105, and a suitable lateral access aperture 120 through the shirt for installing and service the fastener 107.

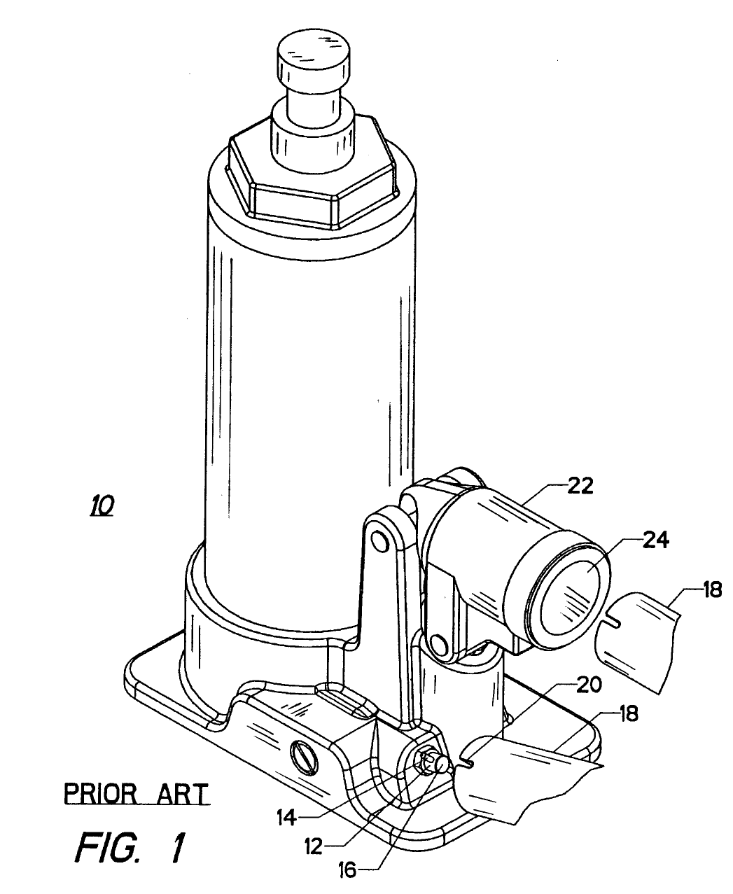

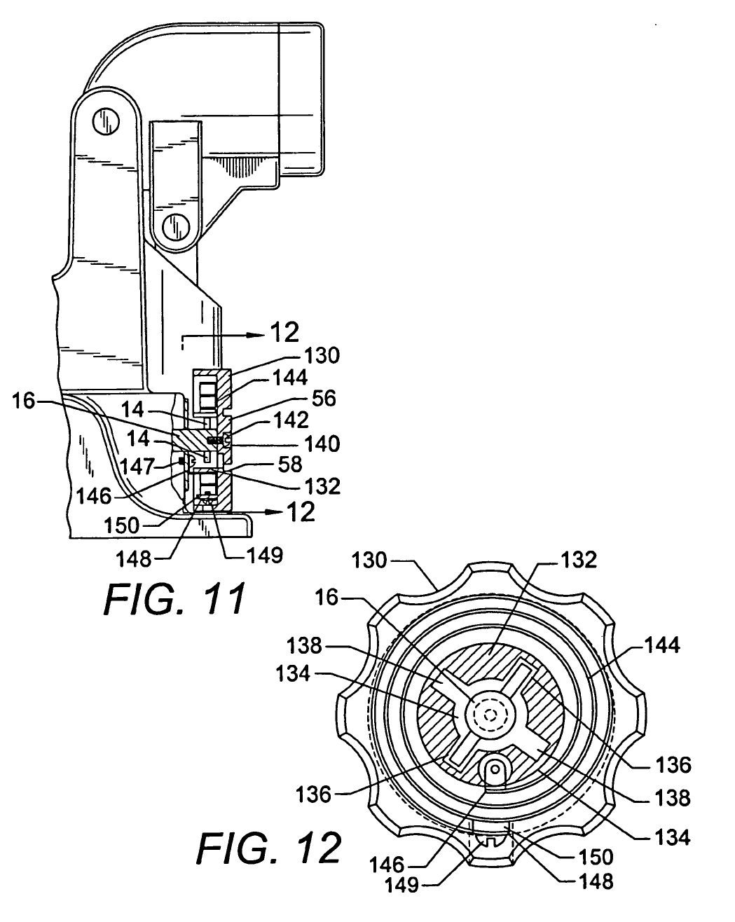

Referring now to FIGS. 1, and 9-13, the existing conventional bottle jack 10 of FIG. 1 can also be retrofit and adapted to a hydraulic bottle jack having a valve control knob (as shown and discussed in reference to new jack 30 in FIG. 2). The retrofit components include a control knob 130 having a generally circular disc structure (about 0.50 inches in depth) with an optimized diameter of about twice the size of the double-key head 16, and that is rotatable without interference with the housing or the supporting surface for the jack (about 1.50 to 2.00 inches in diameter).

The control knob 130 has an outer front face 131 preferably having the extended double-key head 56 within the recessed cylindrical opening 58, and is engagable by the slotted wrench 20 of the tubular handle 18.

The control knob 130 has a unique inner back surface including a central hub 132 having a recessed cavity 134 adapted to fit over the double-key head 16 of the control valve of the conventional jack. This recessed cavity has a cylindrical central opening with a pair of opposed slots 136 for nesting over the opposed pins 14 of the double-key head. The cavity preferably includes another pair of opposed slots 138, arranged perpendicularly to slots 136 also for nesting over the double-key head, and for orienting the knob (90° when desired) on the double-key head.

The control knob 130 is attachable to the rotatable shaft 12 with a suitable fastener, or clipping, or bonding the knob to the rotatable shaft. The control knob preferably has a central aperture 140 for inserting a fastener. The proximal end of the rotatable shaft can be suitably drilled and tapped to receive a threaded screw fastener 142 for securing the knob to the shaft. Alternatively, the hub 132 can have a lateral threaded aperture for receiving a set screw (not shown) for securing the control knob to the rotatable shaft. The knob can further alternatively be secured with a suitable adhesive (i.e. J-B Weld® or other two-part epoxy, etc) to bond the control knob to the rotatable shaft. After the control knob 130 is securely fastened to the rotatable shaft 12, the jack functions as Jack 30 as described in reference to FIG. 2.

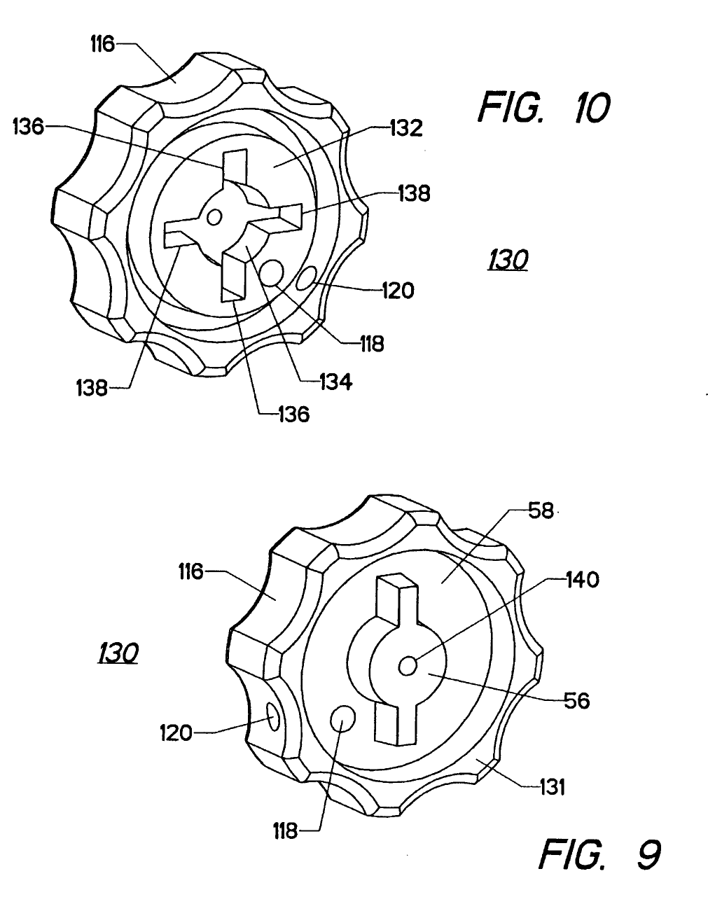

Referring particularly to FIGS. 9 and 10, the control knob 130 is illustrated in more detail. The control knob 130 may also the utilized as a separate “control knob wrench” without permanent attachment to the rotatable shaft 12, to finely adjust the control valve. The control knob wrench can be temporarily positioned onto the rotatable shaft, with the recessed cavity 134 engaged with the double-key head 16, and manually operated to make fine adjustments or otherwise open and close the control valve without the use of the tubular handle 18. The pairs of slotted openings 136 and 138 of the recessed cavity preferably further included flexible detent nipples 139 that tend to grip the lateral pins 14 of the double-key head, to temporarily retain the control knob wrench onto the rotatable shaft.

Referring further to FIGS. 1 and 9-13, a hydraulic bottle jack can be adapted to retrofit the existing conventional bottle jack 10 of FIG. 1, with a control knob and automatic return (as shown and discussed in reference to jack 100 in FIGS. 7 and 8). An example of the retrofit components includes the control knob 130 as previously discussed, and a torsion spring 144.

In this example the torsion spring 144 is a spiral-clock torsion spring (similar to spring 102 as previously discussed in reference to FIG. 7 and 8) having an inner portion with an end 146 attached to the housing with a suitable fastener 147; and having an outer portion with an end 148 attached with a suitable fastener 149 to an inward flange 150 of the control knob (and thus to the rotatable shaft 12). The housing is preferably drilled and taped (about 0.25 inches deep) at a desired location providing a threaded aperture 145 for receiving the fastener 147.

An alternative to drilling and taping the housing, as described above, includes an intervening disc 143 about 1 inch in diameter and about 0.25 inches in thickness positioned over and clear of the rotatable shaft 12, and bonded to the-housing with a suitable adhesive. The disc includes a pre-drilled and taped aperture (145) for receiving the fastener 147. It is preferable to provide directions or a template for properly orienting the disc for a respective model of jack. The use of such a bonded disc precludes drilling into the housing, and precludes any possible damage to any internal fluid passages or leakage of hydraulic fluid.

The spiral-clock torsion spring 144 is sufficiently flexible so that when the respective ends are attached to the housing and to the control knob 130, the control knob can be pulled outward and clear of engagement with the double-key head 16, to find a neutral torsion position of the knob. Once the neutral position is determined, the knob in rotated at least 90° counter-clockwise, and further until the next pair of recessed slots, 136 or 138, in the underside of the hub, are aligned with the double-key head. The knob is then pressed inward to nest and engage the double-key head, now having sufficient pre-loaded torsion force to ensure that the control valve is always biased into the fully closed position.

The control knob is then attached to the rotatable shaft 12 with a suitable fastener 142, or by bonding the knob to the rotatable shaft. As previously discussed, the control knob preferably has the central aperture 140 for inserting a fastener. The proximal end of the rotatable shaft is suitably drilled and tapped to receive the threaded screw fastener 142 to secure the knob to the shaft.

The knob can further alternatively be secured with a suitable adhesive (i.e. J-B Weld® or other two-part epoxy, etc.) to bond the control knob to the rotatable shaft. After the control knob 130 is securely fastened to the control shaft 12, the jack functions as Jack 100 as previously described in reference to FIGS. 7 and 8.

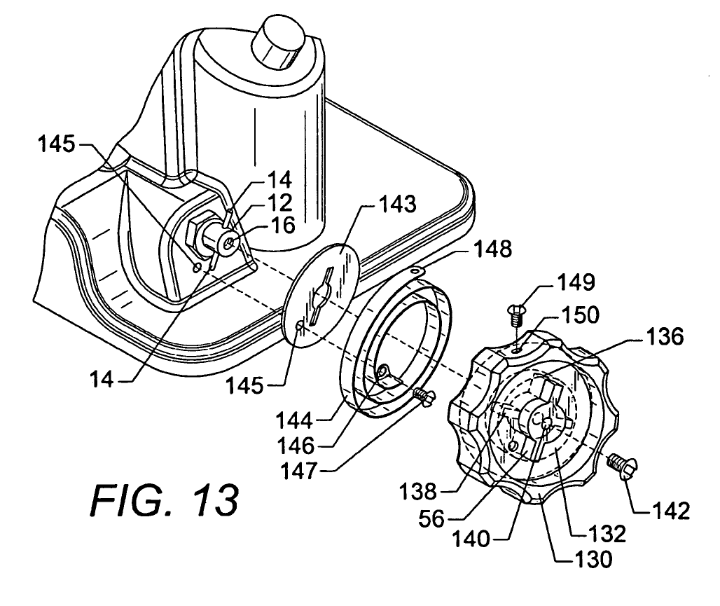

Referring particularly to FIG. 13, the method of performing the retrofit is reviewed in more detail. The control knob, torsion spring, fastener, etc., components may be purchased by the owner of a conventional jack, separately or in “kit” form, with the jack upgraded as a do-it-yourself project by the owner. The upgrade may also be performed by a professional service center, with components provided by the owner or supplied by the service center. A service center can also provide complete jacks that have been retrofit with the features of the present invention, and then sold to the customer.

An example of the method generally includes the following steps:

preparing a desired location of the housing for receiving a fastener, for securing one end of a torsion spring to the housing (this is suitably accomplished by drilling and tapping a threaded aperture 145 into the housing, or by bonding the disc 143, having a threaded aperture 145 therein, to the housing);

securing one end 46 of the spiral-clock torsion spring 144 to the housing;

securing the other end 148 of the spiral-clock torsion spring to the control knob 130;

pulling the control knob outward so that the inner hub thereon is free of any engagement with the double-key head of the rotatable shaft (to determine a neutral torsion position of the control knob);

rotating the control knob counter-clockwise at least 90°, and further until the next pair of slotted opening 136 or 138 are aligned with the pins 14 of the double-key head, to pre-load and sufficiently bias the control knob (and rotatable shaft of the control valve) into the closed position; and

securing the control knob to the rotatable shaft (with a suitable fastener or adhesive).

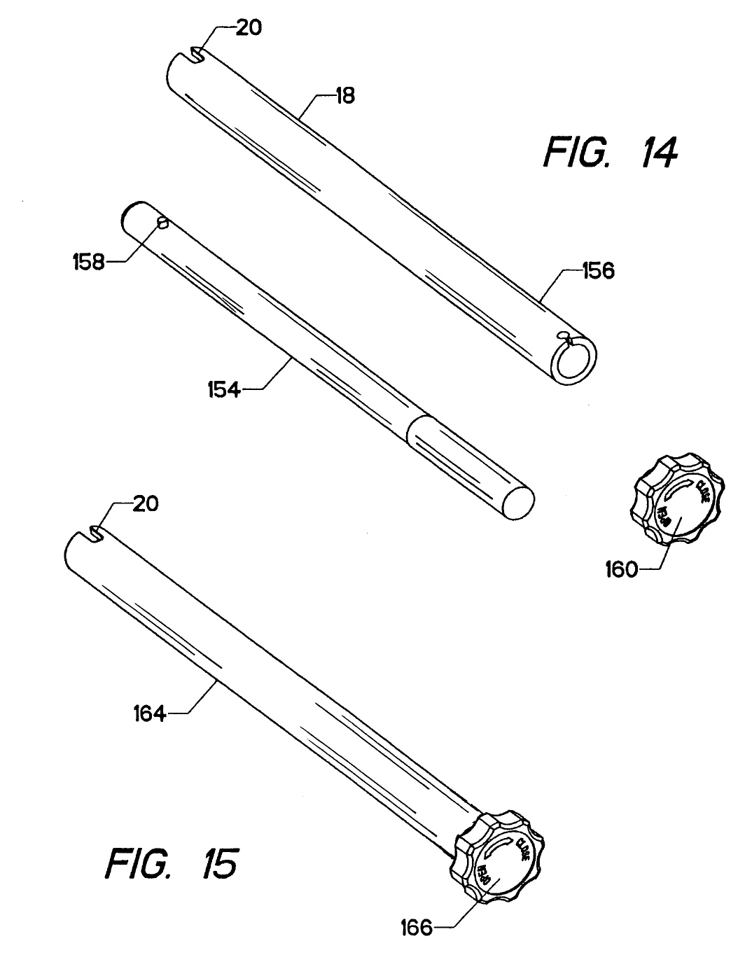

Referring now to FIG. 14, the conventional hydraulic bottle jack 10 is typically provided with a two-piece handle, including the tubular handle 18 and a handle extension 154. As previously discussed the tubular handle has a slotted wrench 20 at the distal end, and has a proximal end for receiving the extension and including a single “bayonet slot” 156. The tubular handle has an inner diameter of about 0.62 inches, an outer diameter of about 0.88 inches, with opposed slotted openings about 0.20 inch wide and about 0.20 inch deep for engaging the double-key head of the jack, and has a length of about 12 inches.

The handle extension 154 is typically a solid rod having a diameter of about 0.60 and a length of about 12 inches, and is insertable into the proximal end of the tubular handle for providing additional leverage to pump the jack. The extension has a radial bayonet stud 158 (about 0.16 inch in diameter and extending about 0.12 inch) about 1 inch from the distal end for mating and engaging with the bayonet slot 156 in the tubular handle to temporarily extend the operating length of the handle.

The tubular handle 18 is improved with the addition of a control knob 160 of the present invention, for providing the desired gradual torque and precise adjustment and control of the control valve of the jack. The control knob has a suitable circular disc configuration having the size and shape as the previously discussed control knobs. The inner surface of the control knob 160 includes a unique hub for temporarily or permanently attaching the knob to the respective tubular handle 18 or the handle extension 154.

The control knob 160 preferably has a central inner cylindrical hub about 0.60 inches in diameter, about 1 inch in length, and having a radial stud (similar to stud 158) for engaging the proximal end and the bayonet slot of the tubular handle 18. A variety of other cylindrical and tubular configurations of the hub and various fasteners can be suitably provided for attaching the knob to the tubular handle.

The control knob 160 can alternatively be provided with an inner central hub for attachment to the proximal end of the handle extension 154. The inner hub is preferably a tubular configuration for enclosing the proximal end of the extension, and having a suitable fastener for securing the knob to the extension. The control knob can alternatively be permanently bonded to the extension with a suitable adhesive. The attachment of the knob to the extension provide for the knob to be available and attachable whenever needed, but otherwise does not encumber routine use requiring only the tubular handle 18 and no precision adjustment of the control valve.

Referring now to FIG. 15, an improved prefabricated handle 164 for a hydraulic bottle jack is provided with a control knob 166 attached to the proximal end of the handle. The handle includes the slotted tubular wrench 20 at the distal end, and the generally circular disc knob at the proximal end having a diameter of about 2.00 inches. The length of the handle suitably ranges for about 12 inches to about 24 inches and preferably is about 18 inches in length. The improved prefabricated handle can be marketed as an after market jack handle, or marketed along with a new conventional jack.

The present invention provides a hydraulic bottle jack with a control valve having a hand operable knob and does not require the use of a tubular handle. The present invention provides a hydraulic bottle jack with a control valve having an automatic return to the closed position. The present invention provides a kit of components and a method for adapting the valve of a conventional hydraulic bottle jack to one having a control knob, and a control knob having an automatic return. The present invention further provides an improved handle with a control knob for use with a hydraulic bottle jack.

While specific embodiments and examples of the present invention have been illustrated and described herein, it is realized that modifications and changes will occur to those skilled in the art. It is therefore to be understood that the appended claims are intended to cover all such modifications and changes as fall within the spirit and scope of the invention.

1. A hydraulic bottle jack having a housing with an internal control valve having an external shaft that is rotatable in the counter-clockwise direction to open the valve for lowering the jack, and rotatable in the clockwise direction for closing the valve for raising the jack, wherein the rotatable shaft further includes a control knob mounted theron for manually rotating the valve.

2. A hydraulic bottle jack as in claim 1 further including means for biasing the control valve into the closed position.

3. A hydraulic bottle jack as in claim 2 wherein the biasing means includes:
a torsion spring having one end fixed to the housing and the other end fixed to said control knob, so that the knob can be rotated in the counter-clockwise direction for opening the control valve; and whereby when the knob is released, the torsion spring automatically forces the knob to rotate back in the clockwise direction for closing the valve.

4. A hydraulic bottle jack as in claim 2 wherein the biasing means includes:
a cylindrical wire torsion spring having an inner coil with the end thereof fixed to the housing, and having an outer coil with the end thereof fixed to said control knob, so that the knob can be rotated in the counter-clockwise direction to open the valve; and whereby when the knob is released, the wire torsion spring automatically forces the knob to rotate back in the clockwise direction to close the valve.

5. A hydraulic bottle jack as in claim 2 wherein the biasing means includes:
a spiral-clock torsion spring having an inner end fixed to the housing and an outer end fixed to said control knob, so that the knob can be rotated in the counter-clockwise direction to open the valve; and whereby when the knob is released, the spiral-clock torsion spring automatically forces the knob to rotate back in the clockwise direction to close the valve.

6. A hydraulic bottle jack having a housing with an internal control valve having an external shaft that is rotatable in the counter-clockwise direction to open the valve for lowering the jack, and is rotatable in the clockwise direction to close the valve for raising the jack wherein the control valve further includes means for biasing the rotatable shaft into the closed position.

7. A hydraulic bottle jack as in claim 6 wherein the biasing means includes:
a torsion spring having one end fixed to the rotatable shaft and the other end fixed to the housing, so that the rotatable shaft can be rotated in the counter-clockwise direction to open the valve; and when the rotatable shaft is released, the torsion spring automatically forces the rotatable shaft to rotate back in the clockwise direction to close the valve.

8. A hydraulic bottle jack as in claim 6 wherein the biasing means includes:
a cylindrical wire torsion spring having an outer coil with an end thereof fixed to the rotatable shaft, and an inner coil with an end thereof fixed to the housing, so that the rotatable shaft can be rotated in the counter-clockwise direction to open the valve; and whereby when the rotatable shaft is released, the torsion spring automatically forces the rotatable shaft to rotate back in the clockwise direction to close the valve.

9. A hydraulic bottle jack as in claim 6 wherein the biasing means includes:
a spiral-clock torsion spring having an inner portion with an end thereof fixed to the housing, and an outer portion having an end thereof fixed to the rotatable shaft, so that the rotatable shaft can be rotated in the counter-clockwise direction to open the control valve; and whereby when the rotatable shaft is released, the torsion spring automatically forces the rotatable shaft to rotate back in the clockwise direction to close the control valve.

10. A control knob wrench, for use with a conventional hydraulic bottle jack having a housing with an internal control valve having an external shaft with a double-key head thereon that is rotatable in the counter-clockwise direction to open the valve for lowering the jack, and is rotatable in the clockwise direction to close the valve for raising the jack, wherein the control knob wrench is a generally circular disc having an inner central hub with a recessed cavity therein adapted to fit over the double-key head of the rotatable shaft for manually rotating the valve.

11. A kit of one or more components including a control knob for use with a hydraulic bottle jack having a housing with an internal control valve having an external shaft with a double-key head thereon for engagement by a slotted wrench tubular handle, and that is rotatable in the counter-clockwise direction to open the valve for lowering the jack, and is rotatable in the clockwise direction to close the valve for raising the jack, wherein the control knob is a generally circular disc having an outer front face with an extended double-key head thereon for engagement by a slotted wrench tubular handle, and the control knob having an inner central hub with a recessed cavity including a central cylindrical opening with a first pair of slotted openings therein adapted to fit over the double-key head of the rotatable shaft for manually rotating the valve, and wherein said control knob is attachable to the rotatable shaft.

12. The kit as in claim 11 further including a torsion spring having one end attachable to the housing and having the other end attachable to the rotatable shaft for biasing the valve in the closed position.

13. The kit of claim 12 wherein the recessed cavity in the inner central hub of the control knob further includes a second pair of slotted openings therein arranged perpendicularly to the first pair of slotted openings adapted to fit over the double-key head of the rotatable shaft for orienting the control knob at a second position on the rotatable shaft.

14. An improved handle for a hydraulic bottle jack wherein the jacks has a housing-with an internal control valve having an external shaft with a double-key head thereon that is rotatable in the counter-clockwise direction to open the valve for lowering the jack, and rotatable in the clockwise direction for closing the valve for raising the jack, wherein the handle includes a tubular shaft having a slotted tubular wrench at the distal end thereof for engaging the double-key head of the jack, and having a proximal end with a control knob having a diameter of about twice the diameter of the tubular shaft for facilitating control of the valve.
